(19) United States
(12) Patent Application Publication
(10) Pub. No.: US 2009/0190117 A1
(43) Pub. Date: Jul. 30, 2009

(54) Exposure apparatus, manufacturing method and supporting method thereof

(75) Inventors: Kazuya Ono, Saitama-shi (JP); Toshimasa Shimoda, Ageo-shi (JP); Yoichi Arai, Honjo-shi (JP); Jin Nishikawa, Tokyo (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/320,267

(22) Filed: Jan. 22, 2009

Related U.S. Application Data
(60) Provisional application No. 61/006,630, filed on Jan. 24, 2008.
(60) Provisional application No. 61/006,631, filed on Jan. 24, 2008.

(51) Int. Cl. G03B 27/54

(52) U.S. Cl. 355/67

(57) ABSTRACT

An exposure apparatus includes an illumination optical system that guides illumination light to a mask; a projection optical system that projects the pattern irradiated with the illumination light, onto a substrate; and a supporting device that integrally suspendingly supports at least part of the illumination optical system and the projection optical system, with a supporting member having a flexible structure.

### CROSS-REFERENCE TO RELATED APPLICATION

This application is a non-provisional application claiming priority to and the benefit of U.S. provisional application Nos. 61/006,630 and 61/006,631, filed Jan. 24, 2008. The entire-contents of which are incorporated herein by reference.

### BACKGROUND

1. Field of the Invention

The present invention relates to an exposure apparatus, and a manufacturing method and a supporting method thereof.

2. Description of Related Art

When manufacturing a semiconductor device or the like, there has been used a projection exposure apparatus that transfers, via a projection optical system, a pattern image of a reticle serving as a mask onto each shot region on a wafer (or glass plate or the like) serving as a substrate having a resist applied thereon. Conventionally, a step-and-repeat method (one-shot exposure type) projection exposure apparatus (stepper) has been frequently used as a projection exposure apparatus. However, a scanning exposure type such as step-and-scan method type projection exposure apparatus (scanning type exposure apparatus) that synchronous-scans a reticle and wafer with respect to a projection optical system to perform exposure, is recently drawing attention.

In the conventional exposure apparatus, driving sections of a reticle stage and a wafer stage that respectively support and transport a reticle, which is a pattern original plate, and a wafer, onto which the pattern is transferred, are fixed to a structure body that supports a projection optical system, and furthermore, the projection optical system in the proximity of its center of gravity is also fixed to this structure body. Moreover, in order to position the wafer stage at a high level of accuracy, the position of the wafer is measured with a laser interferometer, and on the wafer stage there is fitted a movable mirror for the laser interferometer.

In the conventional exposure apparatus mentioned above, the driving section of the wafer stage, and the projection optical system, are fixed to the same structure body. Therefore vibrations caused by the driving reaction force of the stage are transmitted to the structure body and the vibrations are transmitted further to the projection optical system. Moreover all of the mechanical structures mechanically resonate at a predetermined frequency. Therefore, if such vibrations are transmitted to the structure body, deformation or a resonance phenomenon occurs in the structure body, consequently causing positional displacement of the transfer pattern image or reduced contrast.

Consequently, PCT International Publication, No. WO2006/038952 discloses a technique in which there are provided a supporting member that supports a projection optical system, and a connection member that suspendingly supports the projection optical system on a frame via the supporting member having a flexible structure, to thereby suppress vibrations transmitted to a projection optical system, with a comparatively simple mechanism.

The mask is illuminated with illumination light (EUV light) emitted from the illumination optical system, and the illumination light reflected by the reflecting surface of the mask enters the projection optical system as exposure light containing information of the pattern image of the mask. Even in a state where both the projection optical system and the illumination optical system are supported by a frame, if the projection optical system moves relative to the frame for canceling a vibration and the like transmitted to the projection optical system, there is a possibility that positional displacement may occur between the projection optical system and the illumination optical system as a result. In this case, there is a possibility that the characteristics of the mask pattern projection with the projection optical system may be negatively influenced.

A purpose of some aspects of the present invention is to provide an exposure apparatus capable of suppressing vibrations transmitted to the projection optical system, while suppressing any negative influence of the vibrations on the projection characteristic of the projection optical system, and a manufacturing method and a supporting method thereof.

### SUMMARY

According to a first aspect of the present invention, there is provided an exposure apparatus that irradiates illumination light onto a pattern formed on a mask and exposes the pattern on a substrate, and includes: an illumination optical system that guides the illumination light to the mask; a projection optical system that projects the pattern irradiated with the illumination light, onto the substrate; and a supporting device that integrally suspendingly supports a projection optical system and at least a part of the illumination optical system, with a supporting member having a flexible structure.

According to a second aspect of the present invention, there is provided a supporting method for supporting an illumination optical system that guides an illumination light to a mask, and a projection optical system that projects a pattern of the mask illuminated with the illumination light onto a substrate, wherein the method includes: a step of integrally suspendingly supporting the projection optical system and at least a part of the illumination optical system with a supporting member having a flexible structure.

According to a third aspect of the present invention, there is provided a manufacturing method of an exposure apparatus that includes an illumination optical system that guides an illumination light to a mask, and a projection optical system that projects a pattern of the mask illuminated with the illumination light onto a substrate, wherein as a method of supporting at least part of the illumination optical system and the projection optical system, the above mentioned supporting method is employed.

According to a fourth aspect of the present invention, there is provided an exposure apparatus that irradiates illumination light onto a pattern formed on a mask and exposes the pattern on a substrate, and includes: an illumination optical system that guides the illumination light to the mask; a projection optical system that projects the pattern irradiated with the illumination light, onto the substrate; a first supporting device that suspendingly supports at least part of the illumination optical system, with a first supporting member having a flexible structure; and a second supporting device that suspendingly supports the projection optical system separately from the first supporting member, with a second supporting member having a flexible structure.

According to a fifth aspect of the present invention, there is provided a method for supporting an illumination optical system that guides an illumination light to a mask, and a projection optical system that projects a pattern of the mask illuminated with the illumination light onto a substrate, wherein the method includes: a step of suspendingly supporting at least part of the illumination optical system with a first supporting member having a flexible structure; and a step of suspendingly supporting the projection optical system separately from the first supporting member, with a second supporting member having a flexible structure.

According to a sixth aspect of the present invention, there is provided a manufacturing method of an exposure apparatus in which illumination light is irradiated onto a pattern formed on a mask, and the pattern is exposed on a substrate, wherein as a method of supporting at least part of the illumination optical system and the projection optical system, the above mentioned supporting method is employed.

In the first, the second, the fourth, and the fifth aspects, it is possible to suppress vibrations transmitted to the projection optical system while suppressing any negative influence on the projection characteristics of the projection optical system, and it is possible to transfer the mask pattern onto the substrate at a high level of accuracy.

In the third and the sixth aspects, it is possible to provide an exposure apparatus that can suppress a reduction in the projection characteristics caused by positional displacement between the projection optical system and the illumination optical system, and transfer the mask pattern onto the substrate at a high level of accuracy.

### BRIEF DESCRIPTION OF THE DRAWINGS

FIG. 1 is a schematic block diagram showing an exposure apparatus of one embodiment.

FIG. 2 is a drawing schematically showing internal configurations of a light source, an illumination optical system, and a projection optical system.

FIG. 3A is a drawing schematically showing a configuration example of an optical integrator in FIG. 2.

FIG. 3B is a drawing schematically showing a configuration example of an optical integrator in FIG. 2.

FIG. 4 is a drawing for schematically explaining a single scanning exposure.

FIG. 5 shows a situation where a rotational axis of a circular arc shape of an illumination area formed on a mask, is defined as a center of a circle that defines an outer circular arc or inner circular arc.

FIG. 6 is a plan view of the supporting plate that supports the projection optical system and the illumination optical system.

FIG. 7 is a schematic block diagram showing an exposure apparatus of another embodiment.

FIG. 8 is a plan view of the projection optical system, illumination optical system, and a supporting plate.

FIG. 9 is a flow chart showing an example of manufacturing steps of a microdevice of the present invention.

FIG. 10 is a diagram showing an example of detailed steps of step S13 in FIG. 9.

### DESCRIPTION OF EMBODIMENTS

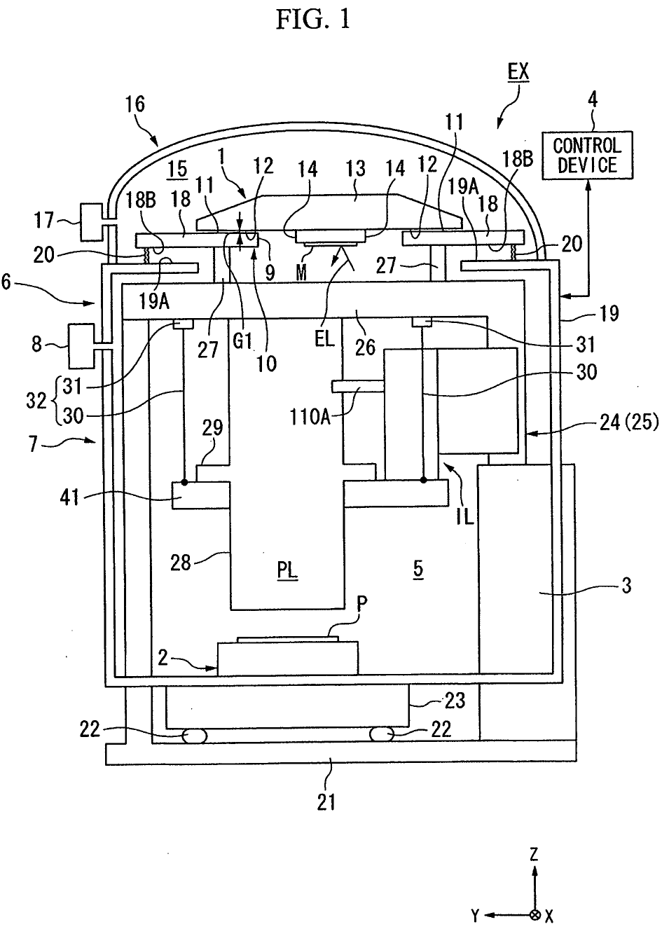

Hereunder, an embodiment of the present invention is described, with reference to FIG. 1 through FIG. 6.

In the respective drawings used for the following description, the scale of each member is appropriately changed so that each member is a recognizable size.

Moreover, in the following description, a predetermined direction within a horizontal plane is made the X axis direction, a direction orthogonal to the X axis direction within the horizontal plane is made the Y axis direction, and a direction orthogonal to both the X axis direction and the Y axis direction (that is, a perpendicular direction) is made the Z axis direction. Furthermore, rotation (inclination) directions about the X axis, the Y axis, and the Z axis, are made the θX, the θY, and the θZ directions respectively.

FIG. 1 is a schematic block diagram showing an exposure apparatus EX according to the present embodiment. In the present embodiment, there is described an example of a case where the exposure apparatus EX is a EUV exposure apparatus that exposes a substrate P with extreme ultraviolet (EUV) light. Extreme ultraviolet light is an electromagnetic wave in the soft X-ray region of approximate wavelength 5 nm to 50 run for example. In the following description, extreme ultraviolet light is accordingly referred to as EUV light. As an example, in the present embodiment, EUV light of wavelength 13.5 nm is used as an exposure light (illumination light) EL.

First, an overview of the exposure apparatus EX according to the present embodiment is described.

In FIG. 1, the exposure apparatus EX comprises: a mask stage 1 capable of moving while holding a mask M on which a pattern is formed; a substrate stage 2 capable of moving while holding the substrate P; a light source device 3 that generates illumination light; an illumination optical system IL that guides the illumination light from the light source device 3 to illuminate the mask M; a projection optical system PL that projects, onto the substrate P, an exposure light EL containing information of a pattern image of the mask M illuminated with the illumination light; and a control device 4 that controls overall operations of the entire exposure apparatus EX. As the substrate P, this may include one where a film of a photosensitive material (resist) or the like is formed on the surface of a base material such as a semiconductor wafer, for example a silicon wafer, to give photosensitivity, or one in which various films such as a protective coat (top coat) are applied separately from a photosensitive film. As the mask M, this may include a reticle on which a device pattern to be projected onto the substrate P is formed.

The mask M is a reflective type mask having multiple layers capable of reflecting EUV light. The exposure apparatus EX is such that the surface (reflecting surface) of the mask M on which a pattern is formed with multiple layers is illuminated with the illumination light (EUV light), and the photosensitive substrate P is exposed with the exposure light EL reflected by the mask M.

The exposure apparatus EX of the present embodiment is provided with a chamber device 6 capable of setting a first space 5, through which the illumination light and exposure light EL travel, to an environment of a predetermined state. The chamber device 6 is provided with a first space forming member 7 that forms the first space 5, through which the exposure light EL travels, and a first adjusting device 8 that adjusts the environment of the first space 5.

In the present embodiment, the first adjusting device 8 includes a vacuum system and adjusts the first space 5 to a vacuum state. The control device 4 uses the first adjusting device 8 to adjust the first space 5, through which the illumination light and exposure light EL travel, to an approximately vacuum state. As an example of the vacuum state, in the present embodiment, the pressure of the first space 5 is adjusted to a reduced-pressure atmosphere of approximately 1×10⁻⁴ [Pa]. The value of the pressure set in this first space 5 is accordingly described as a first pressure value.

The illumination light emitted from the light source device 3 travels through the first space 5. In the present embodiment, in the first space 5 there are arranged at least part of the illumination optical system IL and the projection optical system PL. The illumination light emitted from the light source device 3 travels through the illumination optical system IL arranged in the first space 5 and illuminates the mask M. Then it becomes exposure light EL containing information of a pattern image of the mask M and travels through the projection optical system PL. Moreover, in the present embodiment, in the first space 5 there is arranged the substrate stage 2.

In the description of the present embodiment, the EUV light between emission from the light source device 3 and illumination of the mask M is described as the illumination light, and the EUV light between reflection by the mask M and projection onto the substrate P is described as the exposure light EL. However, these separate names are given only for the sake of facilitating the description, and both of these lights may be treated as the exposure light EL.

The first space forming member 7 has a first opening 9 and a first surface 11 provided around the first opening 9. The first opening 9 is formed in a position where incidence of the illumination light that has traveled through the first space 5 is possible. Moreover, in the present embodiment, the first opening 9 is formed in a position where incidence of the illumination light emitted from the illumination optical system IL is possible.

The mask stage 1 is configured so as to hold the mask M while moving this mask M, and is arranged so as to cover the first opening 9. The mask stage 1 has a second surface 12 that opposes to the first surface provided on the first space forming member 7 (guide member 18), and this second surface 12 is capable of relative movement between itself and the first opening 9 while being guided by the first surface 11. In the present embodiment, between the first surface 11 of the first space forming member 7 and the second surface 12 of the mask stage 1, there is formed a gas sealing mechanism 10. At this time, between the first surface 11 and the second surface 12 there is formed a predetermined gap G1. The gap G1 is adjusted to a predetermined amount (for example, approximately 0.1 to 1 μm), so that gas flow into the inside of the first space 5 through the gap G1 is suppressed. In the present embodiment, the first opening 9 is covered by the mask stage 1, and as mentioned above, the gas sealing mechanism 10 is formed between the first surface 11 and the second surface 12 to thereby bring the first space 5 into a substantially sealed state. As a result, the chamber device 6 can control the first space 5 to a predetermined state (vacuum state).

The mask stage 1 holds the mask M so that the mask M is arranged in the first space 5 via the first opening 9. In the present embodiment, the mask stage 1 holds the mask M so that it is arranged on the +Z side of the first space 5, and the reflecting surface of the mask M faces the −Z side (first space 5 side). Furthermore, in the present embodiment, the mask stage 1 holds the mask M so that the reflecting surface of the mask M and the XY plane become substantially parallel to each other. The illumination light emitted from the illumination optical system IL is irradiated onto the reflecting surface of the mask M held by the mask stage 1.

To describe the mask stage 1 in more detail, the mask stage 1 includes: a first stage 13 configured such that it is larger than the first opening 9, has the second surface 12 formed thereon, and is capable of moving with respect to the first surface 11 and the first opening 9; and a second stage 14 configured such that it is smaller than the first opening 9, and is capable of moving with respect to the first stage 13 while holding the mask M. The first stage 13 is arranged so as to cover the first opening 9, and between the second surface 12 of the first stage 13 and the first surface 11 of the first space forming member 7, there is formed the gas sealing mechanism 10. The first stage 13, while being guided by the first surface 11, is capable of moving with respect to the first surface 11 and the first opening 9. The second stage 14 is arranged on the −Z side of the first stage 13 (first space 5 side). The mask held by the second stage 14 is arranged, via the opening 9, in the first space 5. The second stage 14 is capable, in a state of holding the mask M, of moving with respect to the first stage 13. With such a configuration, the first stage 13 can function as a coarse movement stage for moving the mask M, and the second stage 14 can function as a fine movement stage for moving the mask M. The first stage 13 and the second stage 14, although not shown in the drawing, have a driving device for respectively moving each of the stages.

Moreover, the chamber device 6 is provided with a second member 16 that forms a second space 15 between itself and the outer surface of the first space forming member 7, and a second adjusting device 17 that adjusts the environment of the second space 15. The second space 15 houses at least part of the mask stage 1 (such as the first stage 13). In the present embodiment, the outside of the first space 5 and the second space 15 is an atmospheric space, and the pressure is atmospheric pressure. The second adjusting device 17 adjusts the pressure of the second space 15 to a pressure that is higher than that of the first space 5 and lower than the atmospheric pressure. As an example, in the present embodiment, the pressure of the second space 15 is adjusted to a reduced-pressure atmosphere of approximately 1×10⁻¹ [Pa]. The value of the pressure set in this second space 15 is accordingly described as a second pressure value.

With such a configuration described above, at least part of the mask stage 1 is arranged in the second space 15, and the mask M held by the mask stage 1 is arranged in the first space 5.

The exposure apparatus EX is a scanning type exposure apparatus (so-called scanning stepper) that projects a pattern image of the mask M onto the substrate P while synchronously moving the mask M and the substrate P in a predetermined scanning direction. In the present embodiment, the scanning direction (synchronous moving direction) of the mask M is made the Y axis direction, and the scanning direction (synchronous moving direction) of the substrate P is also made the Y axis direction. The exposure apparatus EX moves a shot region of the substrate P, with respect to the projection region of the projection optical system PL, in the Y axis direction, and in synchronous with the movement of the shot region of the substrate P in the Y axis direction, a pattern formation region of the mask M is moved in the Y axis direction with respect to the illumination region of the illumination optical system IL. Meanwhile, the mask M is illuminated with the exposure light EL, and the exposure light EL from the mask M is irradiated onto the substrate P to thereby expose the substrate P.

The first stage 13 of the mask stage 1 has a comparatively long stroke in the Y axis direction (scanning direction), so that an entire pattern formation region of the mask M passes the illumination region of the illumination optical system IL while scanning-exposing a single shot region on the substrate P. As a result of the first stage 13 moving in the Y axis direction, the second stage 14 supported on the first stage 13 also moves in the Y axis direction along with the first stage 13. Consequently, as a result of the first stage 13 moving in the Y axis direction, the mask M held by the second stage 14 also moves in the Y axis direction along with the first stage 13. The second stage 14 is capable of slightly moving with respect to the first stage 13, and moves with a stroke shorter than that of the first stage 13. Furthermore, the second stage 14 may be made able to move, with respect to the first stage 13, also in the X axis direction with a short stroke.

Moreover, also in the case where the gas sealing mechanism 10 is formed between the first surface 11 of the first space forming member 7 and the second surface 12 of the first stage 13, and the first stage 13 has moved with respect to the first space forming member 7, gas flow into the inside of the first space 5 can be suppressed. Furthermore, in the present embodiment, there is provided a gap adjusting mechanism that adjusts the gap G1 between the first surface 11 and the second surface 12, and the gap G1 between the first surface 11 and the second surface 12 is maintained at a predetermined amount even in a state of moving the first stage 13 with respect to the first space forming member 7.

As a result, even in the case where the first stage 13 is moved with respect to the first space forming member 7, gas flow into the inside of the first space 5 is suppressed.

The first space forming member 7 includes the guide member 18 with the first surface 11 formed thereon, and a chamber member 19 that faces at least a part of the guide member 18. The guide member 18 guides the movement of the mask stage 1. The mask stage 1 (first stage 13), as described above, moves with respect to the first opening 9 while being guided by the first surface 11 of the guide member 18.

The chamber device 6 has, in addition to the first space forming member 7 and the first adjusting device 8, a bellows member 20 that connects the guide member 18 with the chamber member 19. The bellows member 20 has flexibility and is capable of elastic deformation. In the present embodiment, the bellows member 20 is made of stainless steel. Stainless steel has a low level of degassing (outgassing). Therefore, any influence of the bellows member 20 on the first space 5 can be suppressed. Use of the bellows member 20 is merely an example, and another material other than stainless steel with a low level of degassing may also be used.

The first space forming member 7 has the first opening 9 and the first surface 11, and is configured so as to include the guide member 18 and the chamber member 19. The guide member 18, the chamber member 19, the bellows member 20, and the mask stage 1 (primarily the first stage 13) form the substantially sealed first space 5. The chamber member 19 has an upper surface 19A that faces a lower surface 18B of the guide member 18, and the bellows member 20 is arranged so as to connect the lower surface 18B of the guide member 18 with the upper surface 19A of the chamber member 19.

The exposure apparatus EX is provided with a base member 21, and a first supporting member 23 supported on the base member 21 via a first antivibration system 22. The chamber member 19 is supported on the first supporting member 23. Moreover, on the base member 21, there is arranged a first frame member 24. The first frame member 24 includes a supporting column section 25 and a supporting section 26 connected to the upper end of the supporting column section 25. On the supporting section 26 there is connected a second supporting member 27 that supports the lower surface of the guide member 18, and the guide member 18 is supported by the first frame member 24 via the second supporting member 27. The chamber member 19 and the second supporting member 27 are arranged in positions distanced from each other, so that they do not come into direct contact with each other. Moreover, the chamber member 19 and the first frame member 24 are arranged distanced from each other so as to not come into direct contact with each other. Between the chamber member 19 and the first frame member 24 there is arranged a flexible (elastic) sealing mechanism such as a bellows member.

The light source device 3 is a laser produced plasma light source device, namely a so-called LPP (laser produced plasma) type light source device, that irradiates a laser light onto a target material such as xenon (Xe) and turns the target material into plasma to generate EUV light, and it is installed on the base member 21.

As the light source device 3, this may also be a discharge produced plasma light source device, namely a so-called DPP (discharge produced plasma) type light source device, that generates an electrical discharge in a predetermined gas and turns the predetermined gas into plasma to generate EUV light. The EUV light (illumination light) generated by the light source device 3 enters the illumination optical system IL via a wavelength selective filter (not shown in the drawing). Here, the wavelength selective filter, out of the light supplied from the light source device 3, selectively allows only EUV light of a predetermined wavelength (for example, 13.4 nm) to pass therethrough, and has a characteristic to block transmission of light with other wavelengths. The EUV light transmitted through the wavelength selective filter illuminates, via the illumination optical system IL, the reflective type mask (reticle) M having a pattern to be transferred formed thereon.

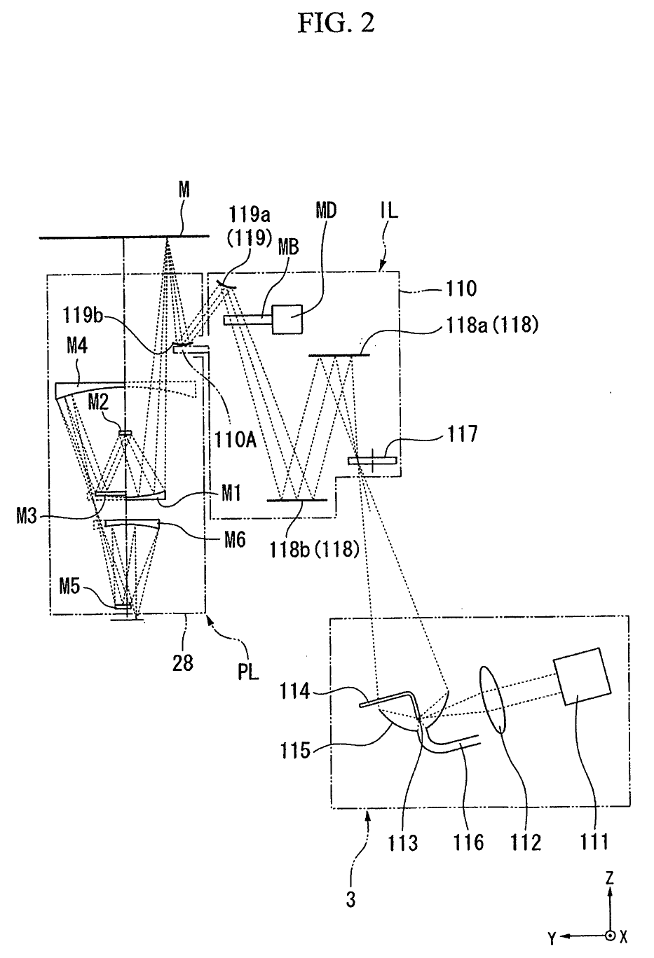

FIG. 2 is a drawing schematically showing internal configurations of the light source device 3, the illumination optical system IL, and the projection optical system PL shown in FIG. 1.

The light source device 3 comprises a laser light source 111, a condensing lens 112, a nozzle 114, an ellipsoidal reflector 115, and a duct 116. The light (non-EUV light) emitted from the laser light source 111 is condensed onto a gaseous target 113 via the condensing lens 112. A high pressure gas that comprises xenon for example is supplied through the nozzle 114, and the gaseous target 113 is formed from the gas injected from this nozzle 114. The gaseous target 113 gains energy from the condensed laser light and turns into plasma, thereby emitting the EUV light. The gaseous target 113 is positioned at a first focal point of the ellipsoidal reflector 115.

Consequently, the EUV light emitted from the light source device 3 is condensed on a second focal point of the ellipsoidal reflector 115. On the other hand, the gas that has completed light emission is suctioned via the duct 116 and guided to the outside of the light source device 3 for example. The EUV light condensed on the second focal point of the ellipsoidal reflector 115 is guided to the illumination optical system IL.

The illumination optical system IL comprises, housed within an illumination lens barrel 110; an optical integrator 118, a condenser optical system 119 or the like, a plurality of optical elements and an ND filter 117 positioned on the mask M side from an intermediate light condensing point of the EUV light, and a blind MB or the like. The ND filter (processing device) 117 is arranged substantially at the second focal point of the ellipsoidal reflector 115, and with operation of a driving device not shown in the drawing, it adjusts the EUV light to a predetermined peak intensity (illuminance adjusting process) according to its position when it has rotated about the Z axis for example.

The EUV light (illumination light) that has transmitted through the ND filter 117 is guided to the optical integrator 118. The optical integrator 118 is configured so as to include a pair of fly-eye optical systems (a first fly-eye optical system 118a and a second fly-eye optical system 118b).

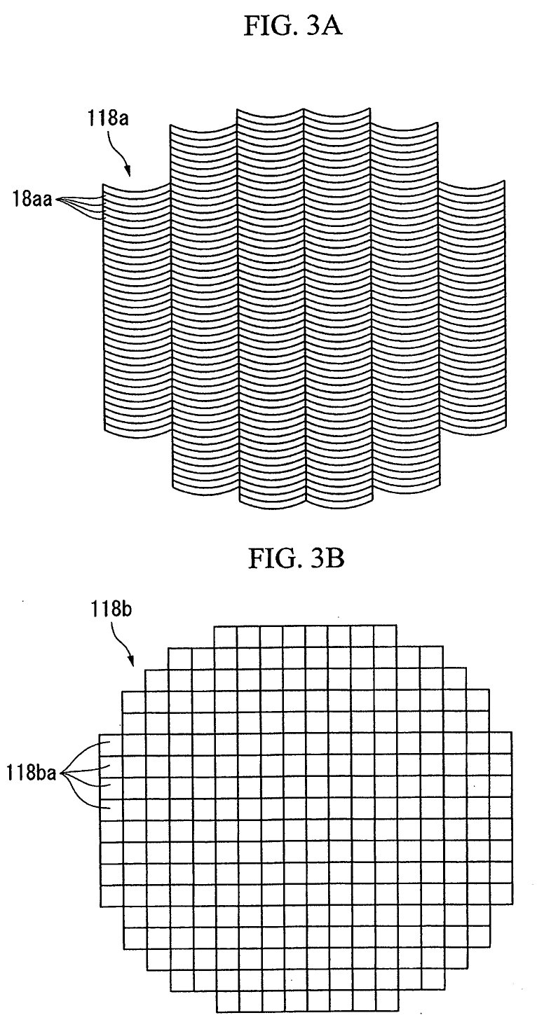

The first fly-eye optical system 118a comprises a plurality of reflective mirror elements 118aa with a circular arc outer shape parallely arranged as shown for example in FIG. 3A. The second fly-eye optical system 118b comprises a plurality of reflective mirror elements 118ba with a rectangle outer shape parallely arranged as shown for example in FIG. 3B so as to have a one-on-one correspondence with the plurality of reflective mirror elements 118aa of the first fly-eye optical system 118a. For specific configurations and effects of the first fly-eye optical system 118a and the second fly-eye optical system 118b, U.S. Pat. No. 6,452,661 is referenced, and the contents thereof are incorporated where possible as a part of the present invention.

Thus, in the proximity of the projection surface of the optical integrator 118, that is, in the proximity of the reflecting surface of the second fly-eye optical system 118b, there is formed a substantive surface light source having a predetermined shape. The substantive surface light source is formed in a position optically conjugated with an exit pupil position of the illumination optical system IL, that is, an entrance pupil of the projection optical system PL. In the proximity of the reflecting surface of the second fly-eye optical system 118b, that is to say, in a position where the substantive surface light source is formed, there is arranged an opening aperture (not shown in FIG. 2). Moreover, between the optical integrator 118 and the condenser optical system 119, there is arranged a blind (processing device) MB that for example forms a circular arc shaped illumination region (illumination region forming process) with operation of a blind driving device MD.

The light from the substantive surface light source is emitted from the illumination optical system IL via the condenser optical system 119 comprising a curved reflecting mirror (convex reflecting mirror or concave reflecting mirror) 119a, the reflecting surface of which has a predetermined curvature, and a concave reflecting mirror 119b. The concave reflecting mirror 119b is supported on an extending section 110A that extends from the illumination lens barrel 110 and that is provided immersed in a projection lens barrel 28 of the projection optical system PL, and is arranged within the projection lens barrel 28.

Here, the condenser optical system 119 is configured so that light from each of the plurality of the reflecting mirror elements of the second fly-eye optical system 118b superimposedly illuminates the mask M. The light (illumination light) emitted from the illumination optical system IL, for example, illuminates the mask M, in a shape regulated by a circular arc shaped opening portion of the blind MB (light transmission section).

Thus, a circular arc shaped illumination region is formed on the surface (reflecting surface) of the mask M. The light source device 3 (111 to 116), the illumination optical system IL (117 to 119), and the blind MB, form an illumination system for Kohler—illuminating the mask M having a predetermined pattern provided thereon.

The light (exposure light EL) containing information of a pattern image reflected by the surface (reflecting surface) of the illuminated mask M is emitted at an emission angle equivalent to the incident angle thereof, and via the projection optical system PL, the mask pattern image is formed in a circular arc-shaped static exposure region on the substrate P. The projection optical system PL comprises a first reflective imaging optical system for forming an intermediate image of the pattern of the mask M, and a second reflective imaging optical system for forming the intermediate image of the pattern of the mask M (secondary image of the pattern of the mask M) on the substrate P. The first reflective imaging optical system comprises four reflecting mirrors M1 to M4, and the second reflective imaging optical system comprises two reflecting mirrors M5 and M6. Moreover, the projection optical system PL is an optical system that is telecentric to the substrate P side (image side).

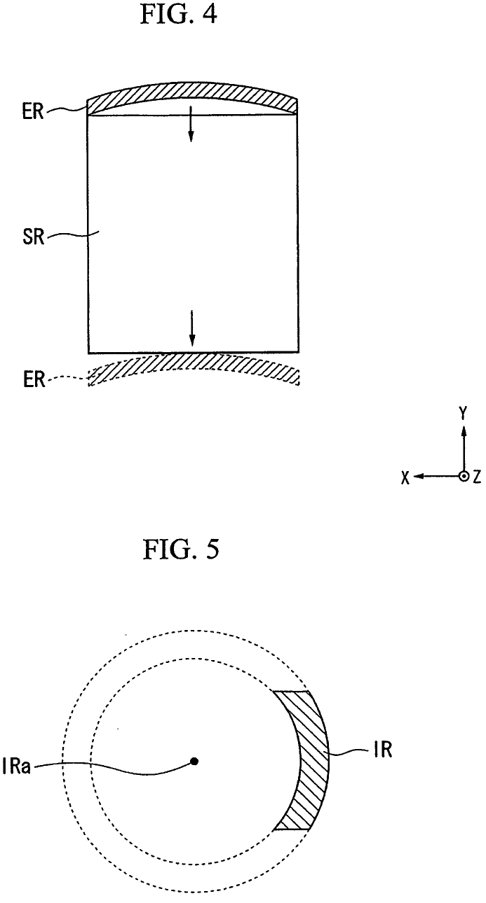

FIG. 4 is a drawing for schematically explaining a single scanning exposure in the present embodiment. Referring to FIG. 4, in the exposure apparatus of the present embodiment, a circular arc-shaped static exposure region (effective exposure region) ER symmetric about the Y axis is formed so as to correspond to a circular arc-shaped effective imaging region and effective view field of the projection optical system PL. When transferring, with a single scanning exposure (scan exposure), the pattern image of the mask M to a rectangular single shot region SR of the substrate P, this circular arc-shaped static exposure region ER moves from a scanning start position indicated with the solid line in the drawing to a scanning end position indicated with the broken line in the drawing.

FIG. 5 shows a situation where a rotational axis of a circular arc shape of an illumination area formed on a mask, is defined as a center of a circle that defines an outer circular arc or inner circular arc. Corresponding to the circular arc-shaped static exposure region ER on the substrate P, as shown in FIG. 5, a circular arc-shaped illumination region IR is formed on the mask M. A rotational axis IRa of the circular arc shape of the illumination region IR is defined as the center of a circle that defines the outer circular arc and inner circular arc of this circular arc shape. If the outer circular arc defining circle and the inner circular arc defining circle of the arch shape of the illumination region IR are not concentric, then the midpoint between the center of one circle and the center of another circle may be defined as the rotational axis. Moreover, in the case where the outer outline defining curved line or the inner outline defining curved line of the circular arc shape of the illumination region IR is not a part of a perfect circle and, for example, is a part of an ellipsoid, the center of the ellipsoid can be considered as the rotational axis. In the present specification, these are all referred to as “rotational axis of the circular arc shape”. As described later, the rotational axis IRa of the circular arc shape of the illumination region IR substantially coincides with the pupil axis that passes through the center of the exit pupil of the illumination optical system and that is perpendicular to the surface of the exit pupil.

Returning to FIG. 1, the plurality of the optical elements (the reflecting mirrors M1 to M6 of the first and second reflective imaging optical systems) that form the projection optical system PL is held by the lens barrel 28. The lens barrel 28 has a flange 29. The projection optical system PL is engaged with a supporting plate 41 at the flange 29 to be supported. The supporting plate 41 integrally supports the illumination optical system IL (the illumination lens barrel 110) and the projection optical system PL.

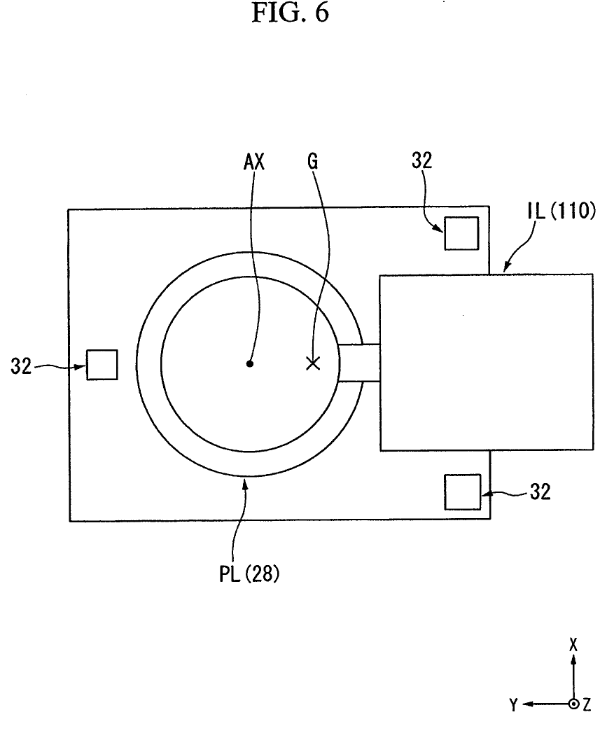

The supporting plate 41 is supported on a supporting section 26 of the first frame member (frame) 24 via a second antivibration system 31 by a supporting member 30 that has a flexible structure. These supporting member 30 and the second antivibration system 31 are arranged, for example, at three locations on the periphery section of the supporting plate 41 so as to serve as supporting devices 32, and integrally suspendingly support the lens barrel 28 (the projection optical system PL) and the illumination lens barrel 110 (illumination optical system IL) from thereabove. Specifically, as shown in FIG. 6, one of the supporting devices 32 is arranged on the +Y side of the projection optical system PL, and each of the rest is respectively arranged, on the ?Y side of the projection optical system PL, on the X direction two sides on either side of the illumination optical system IL. The supporting devices 32 in the three locations are arranged so that the center of gravity position of the combined weight of the illumination optical system IL and the supporting plate 41 becomes the support center. In the embodiment, as shown in FIG. 6, the optical axis AX of the projection optical system PL and the position of the support center within the XY plane are in a mutually displaced positional relationship. However, it is not limited to this, and the positions of the support center and the optical axis AX may be made to coincide.

In the present embodiment, wires are used as the supporting members 30 having a flexible structure. However, rods or the like having a flexer structure formed on the upper and lower ends thereof, or chains, may be used instead. Moreover, between the supporting members 30 and the supporting section 26, there are respectively provided the second antivibration systems 31 (antivibration sections) for reducing vibrations in the Z direction, which is the optical axis direction of the projection optical system PL. The configuration of the supporting device 32 for suspendingly supporting the projection optical system PL and the illumination optical system IL includes the supporting section 26, the supporting member 30, and the second antivibration system 31.

In this configuration, positions of the mask stage 1 and the substrate stage 2 relative to the projection optical system PL are measured, and therefore position control of the mask stage 1 and the substrate stage 2 can always be performed at a high level of accuracy with the projection optical system PL as a reference.

Incidentally, the value of the characteristic frequency fg in a direction perpendicular to the optical axis of the projection optical system PL becomes smaller as the length L of the supporting member 30 becomes longer, and it can be expressed as the following expression.

fg=(g/L)^{1/2}/(2π) (1)

where g is the gravitational acceleration.

As this characteristic frequency fg becomes smaller, vibration isolation performance of the projection optical system PL in the direction perpendicular to the optical axis improves. Therefore a greater length of the supporting member 30 is preferable for improving the vibration isolation performance. However, in order to stably support the projection optical system PL, it is preferable that the supporting plate 41 suspended by the supporting member 30 be fixed in the proximity of the center of gravity of all of the suspended units. Moreover, in order to miniaturize the exposure apparatus as much as possible, it is preferable that the height of the upper end of the supporting section 26 does not exceed the upper end of the projection optical system PL. Consequently, in the present embodiment, the length of the supporting member 30 is made not more than approximately ½ of the Z axis direction length of the projection optical system PL.

The projection optical system PL and the illumination optical system IL, first, are integrally mounted on the supporting plate 41, and then, are integrally suspendingly supported with the connection between the supporting plate 41 and the supporting section 26 of the first frame member 24 by the second antivibration system 31 and the supporting member 30.

The substrate stage 2 is arranged in the interior of the first space 5, and holds the substrate P so that the surface (exposure surface) of the substrate P and the XY plane are substantially parallel to each other. Moreover, the substrate stage 2 holds the substrate P so that the surface of the substrate P faces the +Z direction. The exposure light EL emitted from the projection optical system PL is irradiated onto the substrate P being held on the substrate stage 2.

The substrate stage 2 is capable, while holding the substrate P, of moving in six directions, namely, the X axis, the Y axis, the Z axis, the θX, the θY, and the θZ directions. There are provided a laser interferometer (not shown in the drawing) capable of measuring position information of the substrate stage 2 (substrate P), and a focus leveling detection system (not shown in the drawing) capable of detecting surface position information of the surface of the substrate P, and the control device 4 controls the position of the substrate P held on the substrate stage 2, based on measurement results of the laser interferometer and detection results of the focus leveling detection system.

Next, an example of an operation of the exposure apparatus EX having the above described configuration is described.

The first space 5 is adjusted, by the first adjusting device 8, to a vacuum state (first pressure value). Moreover, the second space 15 is adjusted, by the second adjusting device 17, to a pressure substantially equivalent to the pressure of the first space 5 or to a pressure higher than the pressure of the first space 5 and lower than the atmospheric pressure (second pressure value). Alternatively, the second space 15 may be set to a pressure lower than that of the first space 5. The gap G1 between the first surface 11 and the second surface 12 is adjusted to a predetermined amount, and the gas sealing mechanism 10 formed in between the first surface 11 and the second surface 12 suppresses gas flow into the inside of the first space 5. As a result, the vacuum state and environment of the first space 5 are maintained.

After the mask M has been held on the mask stage 1, and the substrate P has been held on the substrate stage 2, the control device 4 starts an exposure process for the substrate P. In order to illuminate the mask M with illumination light, the control device 4 starts a light emission operation of the light source device 3.

EUV light emitted from the light source device 3 as a result of the light emission operation of the light source device 3 enters the illumination optical system IL. The EUV light that has entered the illumination optical system IL travels through the illumination optical system IL and the peak intensity thereof is adjusted according to the position of the ND filter 117, and furthermore a circular arc shaped illumination region is formed with the blind MB set according to the operation of the blind driving device MD. The EUV light is then supplied to the first opening 9. The EUV light supplied to the first opening 9 serves as an illumination light and enters, via the first opening 9, the mask M held on the mask stage 1. That is to say, the mask M held on the mask stage 1 is illuminated with the illumination light (EUV light) that has been emitted from the light source device 3 and has traveled through the illumination optical system IL. The illumination light that has been irradiated onto the reflecting surface of the mask M and reflected by the reflecting surface, enters as an exposure light EL containing information of a pattern image of the mask M, the projection optical system PL arranged in the first space 5. The exposure light EL that has entered the projection optical system PL, travels through the projection optical system PL, and is then irradiated onto the substrate P held on the substrate stage 2.

The control device 4, in synchronous with the movement of the mask M in the Y axis direction, moves the substrate P in the Y axis direction while illuminating the mask M with the exposure light EL. As a result, the substrate P is exposed with the exposure light EL, and the pattern image of the mask M is projected onto the substrate P.

Here, during the above exposure process, vibrations and stresses from the surroundings transmitted from the first frame member 24 through the supporting device 32 to the supporting plate 41 are blocked by the operation of the second antivibration system 31, and transmission to the projection optical system PL and the illumination optical system IL can be avoided.

There is a possibility that operation of the second antivibration system 31 may cause a movement of the projection optical system PL via the supporting plate 41 relative to the first frame member 24. However, the projection optical system PL and the illumination optical system IL are integrally supported by the supporting plate 41, therefore, there is no relative movement between the projection optical system PL and the illumination optical system IL.

Consequently, in the present embodiment, also when vibrations and stresses are blocked with operation of the second antivibration systems 31, it is possible to maintain the relative positional relationship between the incoming light serving as the illumination light when illuminating the mask M and the outgoing light serving as the exposure light EL containing information of the pattern image of the mask M, while preventing a reduction in the projection characteristics of the projection optical system PL. Especially, in the embodiment, the supporting plate 41, which integrally supports the projection optical system PL and the illumination optical system Il, is used for suspendingly support. Therefore, the excessive configuration can be avoided, and the suspendingly support of the projection optical system PL and the illumination optical system IL can be easily realized.

Furthermore, in the present embodiment, the center of gravity position of the supporting plate 41, the projection optical system PL, and the illumination optical system IL is taken as the support center of the supporting devices 32. Therefore it is possible to suspendingly support the projection optical system PL and the illumination optical system IL with good stability and balance.

Moreover, in the present embodiment, among three of the supporting devices 32, two of the supporting devices 32 are arranged on the two sides on either side of the illumination optical system IL. Therefore, when attaching/detaching the illumination optical system IL to/from the supporting plate 41, it is possible to execute a smooth operation of the attachment/detachment without these supporting devices 32 interfering with the operation.

There is a possibility that operation of the second antivibration system 31 may cause a relative movement between the illumination optical system IL and the light source device 3, and consequently the illuminance of the illumination light (exposure light EL) may be reduced. Therefore, in such a case, by rotating the ND filter 117 via the driving device and adjusting the intensity of the EUV light being transmitted through the ND filter 117, it is possible to compensate (correct) the reduction in the intensity of the illumination light caused by the relative movement between the illumination optical system IL and the light source device 3.

Incidentally, it is possible to appropriately set which optical element present in which part in the optical path of the EUV light between the light source device 3 and the light entry on the mask M, is to be held by the supporting plate 41, and a range that becomes a part of the illumination optical system, may be decided so as to include the optical element supported by the supporting plate 41. As described above, there is a possibility that relative movement may occur between the part supported by the supporting plate 41 and the other parts (for example, the other parts installed on the base member 21). Therefore, in a location where influence of this relative movement becomes insignificant, the part supported by the supporting plate 41 and the parts to be installed in other locations (for example, the base member 21) may be separated from each other. In the case of the present embodiment, the influence is considered to be most insignificant if separated between the ellipsoidal reflector 115 and the second focal point of the ellipsoidal reflector 115. Therefore the ellipsoidal reflector 115 is installed as the light source device 3 on the base member 21, and the ND filter 117 arranged so as to substantially coincide with the second focal point (intermediate light condensing point serving as an illumination light optical path) of the ellipsoidal reflector 115, is supported by the supporting plate 41.

In the embodiment, the configuration is such that the illumination optical system IL is entirely supported by the supporting plate 41. However, the configuration is not limited to this. Alternatively, the illumination optical system IL can be partially supported on the supporting plate 41. Specifically, in the embodiment, the configuration is such that the illumination optical system IL includes the optical element (or optical elements) positioned to the mask side from the intermediate light condensing point (the second focal point of the ellipsoidal reflector 115) in the optical path of the illumination light, and these optical elements are supported by the supporting plate 41. However, in a modified example, the configuration may be such that in the case where the illumination optical system IL has a first optical element (or first optical elements) positioned to the light source side from the intermediate light condensing point, and a second optical element (or second optical elements) positioned to the mask M side from the intermediate light condensing point, the second optical element is suspendingly supported by the supporting plate 41. In this case, the illumination optical system IL can support all of the second optical element(s). Alternatively, the illumination optical system IL can support part of the second optical elements.

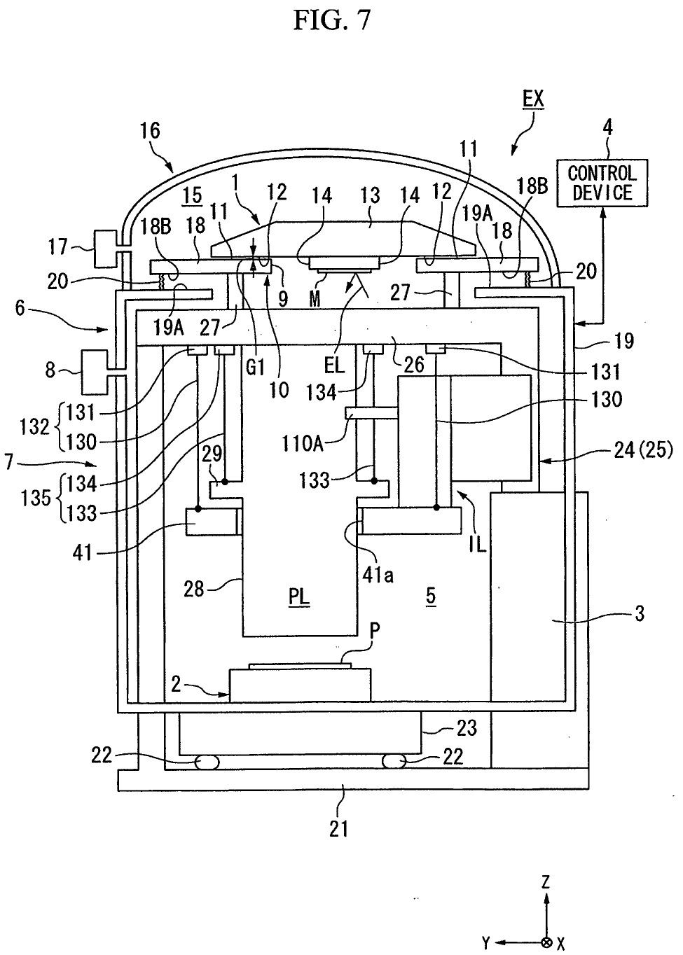

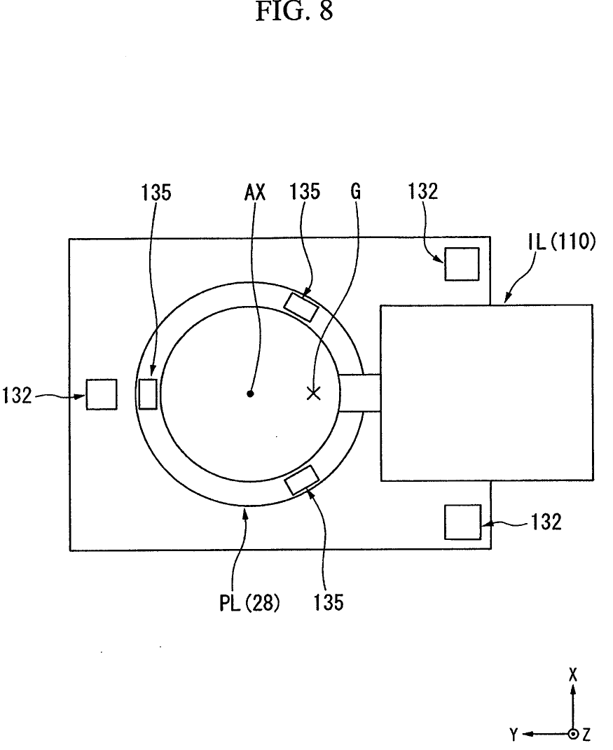

Hereunder, another embodiment of the present invention is described, with reference to FIGS. 7 and 8.

Note that in these figures, constituent parts similar to those of the first embodiment shown in FIG. 1 to FIG. 6 are designated with like reference numerals and are not repetitiously explained.

FIG. 7 is a schematic block diagram showing an exposure apparatus EX according to the present embodiment. In the present embodiment, there is also described an example of a case where the exposure apparatus EX is a EUV exposure apparatus that exposes a substrate P with extreme ultraviolet (EUV) light. Extreme ultraviolet light is an electromagnetic wave in the soft X-ray region of approximate wavelength 5 nm to 50 nm for example. In the following description, extreme ultraviolet light is accordingly referred to as EUV light. As an example, in the present embodiment, EUV light of wavelength 13.5 nm is used as an exposure light (illumination light) EL.

In the embodiment, as shown in FIG. 17, the plurality of the optical elements (the reflecting mirrors M1 to M6 of the first and second reflective imaging optical systems) that form the projection optical system PL is held by the lens barrel 28. The lens barrel 28 has a flange 29. The flange 29 (projection optical system PL) is supported, via a second antivibration system 134, on the supporting section 26 of the first frame member (frame) 24, by a supporting member (second supporting member) 133 having a flexible structure. These supporting member 133 and the second antivibration system 134 are arranged, as shown in FIG. 8, for example, at three locations on the periphery section of the flange 29 so as to serve as supporting devices (second supporting device) 135, and suspendingly support the lens barrel 28 (projection optical system PL) from thereabove.

On the other hand, the illumination optical system IL is also suspendingly supported by the supporting section 26 of the first frame member 24 via a supporting plate 41. Specifically, the illumination optical system IL is supported by the supporting plate 41 from therebelow (−Z side), and the supporting plate 41 is supported, via the second antivibration system 131, on the supporting section 26 of the first frame member 24, by a supporting member (first supporting member) 130 having a flexible structure. These supporting member 130 and the second antivibration system 131 are arranged, for example, at three locations on the periphery section of the supporting plate 41 so as to serve as supporting devices (first supporting device) 132, separately provided from the supporting devices 132, and integrally suspendingly support the supporting plate 41 and the illumination lens barrel 110 (illumination optical system IL) from thereabove. Specifically, as shown in FIG. 8, one of the supporting devices 132 is arranged on the +Y side of the projection optical system PL, and each of the rest is respectively arranged, on the −Y side of the projection optical system PL, on the X direction two sides on either side of the illumination optical system IL. The supporting devices in the three locations that support the supporting plate 41 are arranged so that the center of gravity position of the combined weight of the illumination optical system IL and the supporting plate 41 becomes the support center. In the present embodiment, as shown in FIG. 8, the illumination optical system IL is arranged in a position biased to the supporting plate 41 within the XY plane, and the optical axis AX of the projection optical system PL and the position of the support center within the XY plane, are in a mutually displaced positional relationship. However, it is not limited to this, and the positions of the support center and the optical axis AX may be made to coincide.

In the supporting plate 41, there is formed a hole section 41a, and through the hole section 41a, there is contactlessly inserted the lens barrel 28 of the projection optical system PL.

In the present embodiment, wires are used as the supporting members 130 and 133 having a flexible structure. However, rods or the like having a flexer structure formed on the upper and lower ends thereof, or chains, may be used instead. Moreover, between the supporting members 130 and 133 and the supporting section 26, there are respectively provided the second antivibration systems 131 and 134 (antivibration sections) for reducing vibrations in the Z direction, which is the optical axis direction of the projection optical system PL. The configuration of the supporting device 132 for suspendingly supporting the illumination optical system IL includes the supporting section 26, the supporting member 130, the second antivibration system 131, and the supporting plate 41. Similarly, the configuration of the supporting device 135 for suspendingly supporting the projection optical system PL includes the supporting section 26, the supporting member 133, and the second antivibration system 134.

In this configuration, positions of the mask stage 1 and the substrate stage 2 relative to the projection optical system PL are measured, and therefore position control of the mask stage 1 and the substrate stage 2 can always be performed at a high level of accuracy with the projection optical system PL as a reference.

Incidentally, the value of the characteristic frequency fg in a direction perpendicular to the optical axis of the projection optical system PL becomes smaller as the length L of the supporting member 133 becomes longer, and it can be expressed as the following expression.

fg=(g/L)^{1/2}/(2π) (1)

where g is the gravitational acceleration.

As this characteristic frequency fg becomes smaller, vibration isolation performance of the projection optical system PL in the direction perpendicular to the optical axis improves. Therefore a greater length of the supporting member 133 is preferable for improving the vibration isolation performance. However, in order to stably support the projection optical system PL, it is preferable that the projection optical system PL suspended by the supporting member 133 be fixed in the proximity of the center of gravity of all of the suspended units. Moreover, in order to miniaturize the exposure apparatus as much as possible, it is preferable that the height of the upper end of the supporting section 26 does not exceed the upper end of the projection optical system PL. Consequently, in the present embodiment, the length of the supporting member 133 is made not more than approximately ½ of the Z axis direction length of the projection optical system PL.

Regarding the projection optical system PL and the illumination optical system IL, first, the projection optical system PL is suspendingly supported on the supporting section 26 by the supporting devices 135 (the supporting member 133 and the second antivibration system 134), and then the lens barrel 28 is inserted through the hole section 41a while suspendingly supporting the supporting plate 41 on the supporting section 26 by the supporting devices 132 (the supporting member 130 and the second antivibration system 131). Then, the illumination optical system IL is supported on the supporting plate 41 from the −Y side, and thereby the projection optical system PL and the illumination optical system IL are suspendingly supported on the supporting section 26 while being separated from each other. The procedure may also be such that the supporting plate 41 is suspendingly supported on the supporting section 26 by the supporting devices 132 while the illumination optical system IL is being supported on the supporting plate 41.

Here, during the above exposure process, vibrations and stresses from the surroundings transmitted from the first frame member 24 through the supporting device 132 to the supporting plate 41 are blocked by the operation of the second antivibration system 131, and transmission of the vibrations and stresses to the illumination optical system IL can be avoided.

Similarly, during the exposure process, vibrations and stresses from the surroundings transmitted from the first frame member 24 through the supporting device 135 to the lens barrel 28 (flange 29) are blocked by the operation of the second antivibration system 134, and transmission of the vibrations and stresses to the projection optical system PL can be avoided.

Thus, the influence of vibrations and stresses transmitted from the first frame member 24, on the projection optical system PL and the illumination optical system IL can be avoided, and it is therefore possible to suppress variation in the relative positional relationship between the projection optical system PL and the illumination optical system IL.

Consequently, in the present embodiment, also when vibrations and stresses are blocked with operation of the second antivibration systems 131 and 134, it is possible to maintain the relative positional relationship between the incoming light serving as the illumination light when illuminating the mask M and the outgoing light serving as the exposure light EL containing information of the pattern image of the mask M, while preventing a reduction in the projection characteristics of the projection optical system PL.

Moreover, in the present embodiment, the supporting devices 132 and 135 are separated from each other, and thereby the illumination optical system IL and the projection optical system PL can be separated from each other. Therefore, it is possible to prevent transmission of vibrations and temperature changes, caused by the operation of the blind MB and the ND filter 117, to the projection optical system PL, and negative influences thereof.

Furthermore, in the present embodiment, the center of gravity position of the supporting plate 41 and the illumination optical system IL is taken as the support center of the supporting devices 132. Therefore it is possible to suspendingly support the illumination optical system IL with good stability and balance.

Moreover, in the present embodiment, among three of the supporting devices 132, two of the supporting devices 132 are arranged on the two sides on either side of the illumination optical system IL. Therefore, when attaching/detaching the illumination optical system IL to/from the supporting plate 41, it is possible to execute a smooth operation of the attachment/detachment without these supporting devices 132 interfering with the operation.

There is a possibility that operation of the second antivibration system 131 may cause a relative movement between the illumination optical system IL and the light source device 3, and consequently the illuminance of the illumination light (exposure light EL) may be reduced. Therefore, in such a case, by rotating the ND filter 117 via the driving device and adjusting the intensity of the EUV light being transmitted through the ND filter 117, it is possible to compensate (correct) the reduction in the intensity of the illumination light caused by the relative movement between the illumination optical system IL and the light source device 3. Even in such a case, the projection optical system PL and the illumination optical system IL are separated from each other. Therefore it is possible to suppress the transmission of vibrations and temperature changes accompanying the driving of the ND filter 117, to the projection optical system PL, and the negative influences thereof exerted on the projection characteristic.

Incidentally, it is possible to appropriately set which optical element present in which part in the optical path of the EUV light between the light source device 3 and the light entry on the mask M, is to be held by the supporting plate 41, and a range that becomes a part of the illumination optical system, may be decided so as to include the optical element supported by the supporting plate 41. As described above, there is a possibility that relative movement may occur between the part supported by the supporting plate 41 and the other parts (for example, the other parts installed on the base member 21). Therefore, in a location where influence of this relative movement becomes insignificant, the part supported by the supporting plate 41 and the parts to be installed in other locations (for example, the base member 21) may be separated from each other. In the case of the present embodiment, the influence is considered to be most insignificant if separated between the ellipsoidal reflector 115 and the second focal point of the ellipsoidal reflector 115. Therefore the ellipsoidal reflector 115 is installed as the light source device 3 on the base member 21, and the ND filter 117 arranged so as to substantially coincide with the second focal point (intermediate light condensing point serving as an illumination light optical path) of the ellipsoidal reflector 115, is supported by the supporting plate 41.

Moreover, there is a possibility that a relative movement may occur between the illumination optical system IL and the projection optical system PL, and consequently it may not be possible to achieve a required level of accuracy. In such a case, there may be provided a detection device that finds information related to a positional relationship between the illumination optical system IL and the projection optical system PL, and in order to bring the found positional relationship to a predetermined state, the position of the illumination optical system IL or the projection optical system PL, or the positions of both of them may be moved by a driving device provided in one of or both of the illumination optical system IL and the projection optical system PL.

In the embodiment, the configuration is such that the illumination optical system IL is entirely supported by the supporting plate 41. However, the configuration is not limited to this. Alternatively, the illumination optical system IL can be partially supported on the supporting plate 41. Specifically, in the embodiment, the configuration is such that the illumination optical system IL includes the optical elements positioned to the mask side from the intermediate light condensing point (the second focal point of the ellipsoidal reflector 115) in the optical path of the illumination light, and these optical elements are supported by the supporting plate 41. In a modified example, the configuration may be such that in the case where the illumination optical system IL has a first optical element positioned to the light source side from the intermediate light condensing point, and a second optical element positioned to the mask M side from the intermediate light condensing point, the second optical element is suspendingly supported by the supporting plate 41.

Alternatively or also, the configuration can such that a tubular body is connected to the illumination optical system IL and a temperature adjustment medium (refrigerant) is supplied, in order to suppress temperature changes in the illumination optical system IL. As a result it is possible to suppress temperature changes in the illumination optical system IL caused by heat energy imparted from the illumination light, and heat that is produced accompanying the driving of the blind MB or the ND filter 117. In addition it is possible to eliminate the negative influence thereof imparted on the projection optical system PL.

Furthermore, in the embodiment, the configuration is such that the blind MB, the blind driving device MD, and the ND filter 117 are provided in the illumination lens barrel 110. However, the configuration is not limited to this. Alternatively, it is also possible, by providing at least one of these components separated from the illumination lens barrel 110 and the projection optical system PL, to further reduce the negative influence of vibrations and temperature changes accompanying the operation of these components, on the illumination lens barrel 110 and the projection optical system PL.

The preferred embodiment of the present invention has been described with reference to the accompanying drawings. However, needless to say, the present invention is not limited to the related example. The shapes and combinations of the respective component members shown in the above described example are merely an example, and various kinds of modifications may be possible based on design requirements, without departing from the spirit and scope of the present invention.

As the substrate (object) in the above respective embodiments, not only a semiconductor wafer for semiconductor device manufacturing, but also a glass substrate for a display device, a ceramic wafer for a thin film magnetic head, a mask or a reticle original plate (synthetic quartz, silicon wafer) used in an exposure apparatus, or by a film member or the like may be applied. In addition, the shape of the substrate is not limited to being a circular shape, and may be another shape such as a rectangle or the like.

As the exposure apparatus EX, in addition to a scanning type exposure apparatus of the step-and-scan method (scanning stepper) that synchronously moves the mask M and the substrate P to scan-expose a pattern of the mask M, the present invention may be applied to a projection exposure apparatus (stepper) of the step-and-repeat method that performs one-shot exposure of a pattern of the mask M while the mask M and the substrate P are still, and the substrate P is sequentially step-moved. Moreover, the present invention may be applied to an exposure apparatus of the step-and-stitch method that transfers, on the substrate P, at least two patterns with partial superimposition.

Furthermore, the present invention may also be applied to an exposure apparatus, for example, as disclosed in U.S. Pat. No. 6,611,316, that combines, via a projection optical system, two mask patterns on a substrate, and in a single scanning exposure, a single shot region on the substrate is double-exposed virtually simultaneously.

As the type of exposure apparatus, in addition to an exposure apparatus for semiconductor device manufacturing that exposes a semiconductor device pattern onto the substrate P, the present invention may also be widely applied to an exposure apparatus for liquid crystal display device manufacturing or display manufacturing, or an exposure apparatus for manufacturing a thin film magnetic head, image capturing device (CCD), micro machine, MEMS, DNA chip, or reticle or mask.

Moreover, in the present embodiment, there has been described an example where the exposure light EL is EUV light. However, as the exposure light EL, far ultraviolet light (DUV light) such as emission line (g line, h line, i line) emitted, for example, from a mercury lamp, and KrF excimer laser light (wavelength 248 nm), and vacuum ultraviolet light (VUV light) such as ArF excimer laser light (wavelength 193 nm) and F2 laser light (wavelength 157 nm) may also be used. In this case, the first space 5 does not always need to be adjusted to a vacuum state, and for example, the first space 5 may be filled with a first gas. In the case of filling the first space 5 with the first gas, in order to maintain the environment of the first space 5 filled with the first gas, the gas sealing mechanism 10 of the present embodiment can be used. Moreover, the second space 15 formed with the second member 16 can be filled with a second gas.

Furthermore, the present invention may be applied to a twin-stage type exposure apparatus in which a plurality of substrate stages (wafer stages) are provided. Structures and exposure operations of a twin-stage type exposure apparatus are disclosed, for example, in Japanese Unexamined Patent Application, First Publication No. Hei 10-163099 and Japanese Unexamined Patent Application, First Publication No. Hei 10-214783 (corresponding U.S. Pat. Nos. 6,341,007, 6,400,441, 6,549,269, and 6,590,634), Published Japanese translation No. 2000-505958 of PCT International Publication (corresponding U.S. Pat. No. 5,969,441), or U.S. Pat. No. 6,208,407. Furthermore, the present invention may be applied to a wafer stage disclosed in Japanese Patent Application No. 2004-168481, previously filed by the present applicant.

Moreover, an exposure apparatus to which the present invention is applied is manufactured by assembling various types of sub-systems including the respective components while maintaining a predetermined level of mechanical accuracy, electrical accuracy, and optical accuracy. In order to ensure each of these types of accuracies, before and after this assembly, adjustment to achieve an optical accuracy for various types of optical systems, adjustment to achieve a mechanical accuracy for various mechanical systems, and adjustment to achieve an electrical accuracy for various electrical systems, are respectively performed. A process for assembly an exposure apparatus from the various types of sub-systems includes; mechanical connections, wiring connections of electric circuits, pipe connections of pressure circuits, and so forth between the various types of sub-systems. Prior to the process for assembly the exposure apparatus from these various types of sub-systems, needless to say there are individual assembly steps for the respective sub-systems. After the process of assembly the exposure apparatus from the various types of sub-systems to has been completed, overall adjustments are performed to ensure the various types of accuracies as an entire exposure apparatus. It is preferable that manufacturing of the exposure apparatus is performed in a clean room where room temperature and level of cleanness are managed.

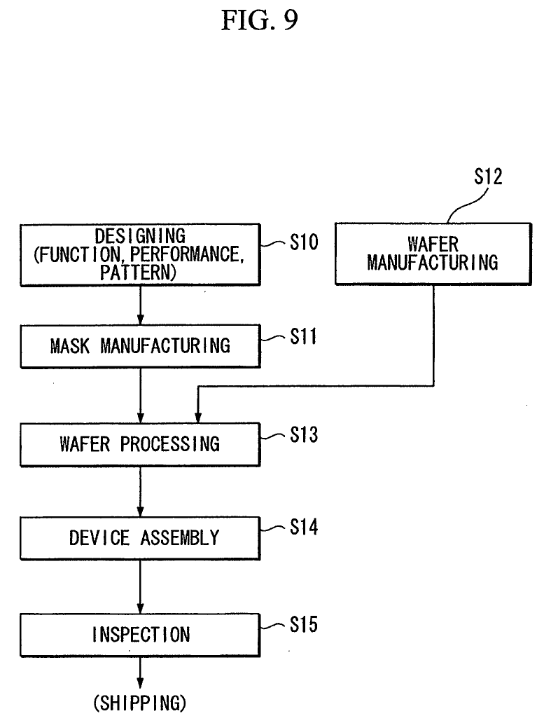

Next, an embodiment of a microdevice manufacturing method is described, in which the exposure apparatus and exposure method according to the embodiment of the present invention are used in a lithography process. FIG. 9 is a diagram showing a flow chart of an example of manufacturing a microdevice (semiconductor chip such as an IC or LSI, liquid crystal panel, CCD, thin film magnetic head, micro machine, or the like).

First, in step S10 (designing step), function and performance design of the microdevice is performed (for example, circuit design of a semiconductor device), and pattern design for achieving those functions is performed. Subsequently, in step S11 (mask manufacturing step), a mask (reticle) on which the designed circuit pattern is formed is manufactured. Meanwhile, in step S12 (wafer manufacturing step), a wafer is manufactured with use of materials such as silicon.

Next, in step S13 (wafer processing step), with use of the mask and the wafer prepared in step S10 to step S12, an actual circuit and so forth are formed on the wafer by means of a lithography technique as described later. Subsequently, in step S14 (device assembly step), assembly of the device is performed with use of the wafer processed in step S13. In this step S14, as necessary, there are included processes such as a dicing process, a bonding process, and a packaging process (chip enclosure). Finally, in step S15 (inspection step), inspections for the microdevice manufactured in step S14 such as an operation check test and an endurance test are performed. After passing through these processes, the microdevice is completed and shipped.

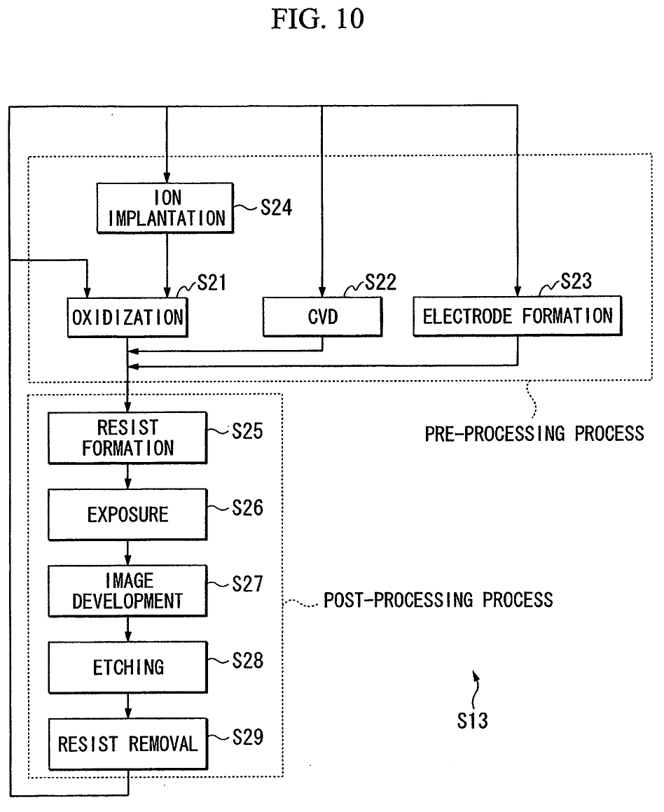

FIG. 10 is a diagram showing an example of detailed steps in step S13, in the case of a semiconductor device.

In step S21 (oxidizing step), the surface of the wafer is oxidized. In step S22 (CVD step), an insulating film is formed on the wafer surface. In step S23 (electrode formation step), electrodes are formed on the wafer by means of deposition. In step S24 (ion implantation step), ions are implanted into the wafer. Each of the above steps S21 to S24 constitutes a pre-processing process for each step of wafer processing, and is selected and executed according to the required process in each of the steps.

In each step of the wafer processing, when the above mentioned pre-processing process has been completed, a post-processing process is executed as described below. In this post-processing process, first, in step S25 (resist formation step), a photosensitive agent is applied onto the wafer. Subsequently, in step S26 (exposure step), the circuit pattern of the mask is transferred onto the wafer with the lithography system (exposure apparatus) and exposure method described above. Next, in step S27 (image-development step), the exposed wafer is image-developed, and in step S28 (etching step), exposed members on the parts other than the part with resist remaining thereon are removed by means of etching. Then in step S29 (resist removal step), the resist that has become unnecessary after the etching, is removed. These pre-processing processes and post-processing process are repeatedly performed, and thereby circuit patterns are multiply formed on the wafer.

Moreover, in addition to microdevices such as semiconductor devices, the present invention may also be applied to an exposure apparatus that transfers circuit patterns from a mother reticle onto a glass substrate, silicon wafer or the like, in order to manufacture a reticle or a mask to be used in a light exposure apparatus, EUV exposure apparatus, X ray exposure apparatus, electron beam exposure apparatus, or the like. Here, in an exposure apparatus that uses DUV (deep ultraviolet) light, VUV (vacuum ultraviolet) light, or the like, a transmission type reticle is used in general, and as a reticle substrate, fused quartz glass, fused quartz glass doped with fluorine, fluorite, magnesium fluoride, crystal, or the like is used. Furthermore, in an X-ray exposure apparatus of a proximity method or an electron beam exposure apparatus, a transmission type mask (stencil mask, membrane mask) is employed, and as the substrate of the mask, a silicon wafer or the like is employed. Exposure apparatuses such as this are disclosed in WO99/34255, WO99/50712, WO/99/66370, Japanese Unexamined Patent Application, First Publication No. Hei 11-194479, Japanese Unexamined Patent Application, First Publication No. 2000-12453, Japanese Unexamined Patent Application, First Publication No. 2000-29202, and so forth.

As far as is permitted, the disclosures in all of the Patent Publications and U.S. patents related to exposure apparatuses and the like cited in the above respective embodiments and modified examples, are incorporated herein by reference.

Consequently, in one embodiment, the projection optical system is suspendingly supported by the supporting member having a flexible structure. Therefore it is possible to suppress transmission of vibrations from a structure body such as frame to the projection optical system, and to suppress positional displacement in these, and prevent positional displacement of transfer pattern images, and reduced contrast.

Moreover, in the embodiment, both the projection optical system and at least a part of the illumination optical system are supported by the supporting member. Therefore, even in a state where the projection optical system moves relative to the structure, it is possible to maintain the relative positional relationship between the projection optical system and at least a part of the illumination optical system, and to suppress a reduction in the projection characteristics caused by positional displacement between the projection optical system and at least a part of the illumination optical system.

In another embodiment, the projection optical system is suspendingly supported by the first supporting member having a flexible structure. Therefore transmission of vibrations from a structure body such as frame to the projection optical system can be suppressed.

Moreover, in the embodiment, the illumination optical system is suspendingly supported by the second supporting member having a flexible structure. Therefore transmission of vibrations from a structure body such as frame to the illumination optical system can be suppressed. Consequently, in the present invention, vibrations from the frame can be suppressed from being transmitted to both of the projection optical system and the illumination optical system. Therefore it is possible to suppress positional displacement in these, and prevent positional displacement of transfer pattern images, and reduced contrast.

Moreover, in the embodiment, the projection optical system and at least part of the illumination optical system are separated from each other by the first supporting member and the second supporting member. Therefore it is possible to prevent transmission of vibrations and heat, for example, caused by operations of a driving mechanism provided respectively in the projection optical system and the illumination optical system, and consequential negative influence thereof on exposure accuracy.

The flexible structure in the present invention is a member that enables a lighter and inexpensive configuration compared to a rigid structure, and thereby offers a preferable characteristic in suppressing transmission of vibrations and thermal displacement. Therefore, the influence of vibrations on the projection optical system and the illumination optical system can be reduced.

1. An exposure apparatus comprising:
an illumination optical system that guides illumination light to a mask onto which a pattern is formed;
a projection optical system that projects the pattern irradiated with the illumination light, onto a substrate;
a first supporting device that suspendingly supports at least a part of the illumination optical system, with a first supporting member having a flexible structure; and
a supporting device that integrally suspendingly supports a projection optical system and at least a part of the illumination optical system, with a supporting member having a flexible structure.

2. An exposure apparatus according to claim 1, wherein the supporting device suspendingly supports a supporting plate that integrally supports the projection optical system and at least a part of the illumination optical system.

3. An exposure apparatus according to claim 2, the first supporting members is arranged at each of plural positions, with a center of gravity position of the projection optical system, the support plate, and at least a part of the illumination optical system as a support center.

4. An exposure apparatus according to claim 3, wherein the support center is arranged at a position displaced from an optical axis of the illumination optical system.

5. An exposure apparatus according to claim 1, wherein
the illumination optical system has a plurality of optical elements, and
the supporting device supports, out of the plurality of optical elements, supports at least one optical element positioned on the mask side from an intermediate light condensing point of the illumination light in an optical path of the illumination light.

6. An exposure apparatus according to claim 5, wherein
the illumination optical system has at least one first optical element positioned to a light source side from the intermediate light condensing point in the optical path, and at least one second optical element positioned to the mask side from the intermediate light condensing point in the optical path,
and the at least one second optical element is supported on the supporting device.

7. An exposure apparatus according to claim 1, wherein the illumination optical system includes a plurality of reflecting surfaces, and of the reflecting surfaces, a shape of a reflecting surface closest to the mask along an optical path of the illumination light has curvature.

8. A supporting method for supporting an illumination optical system that guides an illumination light to a mask, and a projection optical system that projects a pattern of the mask illuminated with the illumination light onto a substrate, the method comprising:
integrally suspendingly supporting the projection optical system and at least a part of the illumination optical system with a supporting member having a flexible structure.

9. A supporting method according to claim 8, wherein the supporting comprises:
integrally supporting the projection optical system and at least a part of the illumination optical system on a support plate; and
suspending the support plate on the frame via the first supporting member.

10. A supporting method according to claim 9, wherein the first supporting member is arranged at each of plural positions, with a center of gravity position of the projection optical system, the support plate, and at least a part of the illumination optical system as a support center.

11. A supporting method according to claim 10, wherein the support center is arranged at a position displaced from an optical axis of the illumination optical system.

12. A supporting method according to claim 8, wherein
the illumination optical system has a plurality of optical elements, and
out of the plurality of optical elements, at least one optical element positioned on the mask side from an intermediate light condensing point of the illumination light in an optical path of the illumination light is suspendingly supported.

13. A supporting method according to claim 12, wherein
the illumination optical system has at least one first optical element positioned to a light source side from the intermediate light condensing point in the optical path, and at least one second optical element positioned to the mask side from the intermediate light condensing point in the optical path,
and at least one the second optical element is suspendingly supported.

14. A supporting method according to claim 8, wherein the illumination optical system includes a plurality of reflecting surfaces, and of the reflecting surfaces, a shape of a reflecting surface closest to the mask along an optical path of the illumination light has curvature.

15. A manufacturing method of an exposure apparatus that comprises an illumination optical system that guides an illumination light to a mask, and a projection optical system that projects a pattern of the mask illuminated with the illumination light onto a substrate, wherein
as a method of supporting at least part of the illumination optical system and the projection optical system, a supporting method according to claim 8 is employed.

16. An exposure apparatus comprising:
an illumination optical system that guides illumination light to a mask on which a pattern is formed;
a projection optical system that projects the pattern irradiated with the illumination light, onto a substrate;
a first supporting device that suspendingly supports at least part of the illumination optical system, with a first supporting member having a flexible structure; and
a second supporting device that suspendingly supports the projection optical system separately from the first supporting member, with a second supporting member having a flexible structure.

17. An exposure apparatus according to claim 16, wherein the first supporting device suspendingly supports a support plate that supports at least a part of the illumination optical system, and
a plurality of the first supporting members is arranged at each of plural positions, with a center of gravity position of the support plate and at least a part of the illumination optical system as a support center.

18. An exposure apparatus according to claim 17, wherein the support center is arranged at a position displaced from an optical axis of the illumination optical system.

19. An exposure apparatus according to claim 16, wherein
the illumination optical system has a plurality of optical elements, and
the first supporting device, out of the plurality of optical elements, supports at least one optical element positioned on the mask side from an intermediate light condensing point of the illumination light in an optical path of the illumination light.

20. An exposure apparatus according to claim 19, wherein
the illumination optical system has at least one first optical element positioned to a light source side from the intermediate light condensing point in the optical path, and at least one second optical element positioned to the mask side from the intermediate light condensing point in the optical path,
and at least one the second optical element is supported on the first supporting device.

21. An exposure apparatus according to claim 16, wherein the illumination optical system includes a plurality of reflecting surfaces, and of the reflecting surfaces, a shape of a reflecting surface closest to the mask along an optical path of the illumination light has curvature.

22. An exposure apparatus according to claim 16, wherein on at least a part of the illumination optical system is installed a processing device that is driven with respect to an optical path of the illumination light to perform predetermined processing with respect to the illumination light.

23. An exposure apparatus according to claim 16, wherein to at least a part of the illumination optical system is connected a tubular body that supplies a temperature adjustment medium.

24. A supporting method for supporting an illumination optical system that guides an illumination light to a mask, and a projection optical system that projects a pattern of the mask illuminated with the illumination light onto a substrate, the method comprising:
suspendingly supporting at least part of the illumination optical system with a first supporting member having a flexible structure; and
suspendingly supporting the projection optical system separately from the first supporting member, with a second supporting member having a flexible structure.

25. A supporting method according to claim 24, wherein the supporting comprises:
supporting at least a part of the illumination optical system on a support plate, and
suspending the support plate on the frame via the first supporting member,
and the first supporting member is arranged at each of plural positions, with a center of gravity position of the support plate and at least a part of the illumination optical system as a support center.

26. A supporting method according to claim 25, wherein the support center is arranged at a position displaced from an optical axis of the illumination optical system.

27. A supporting method according to claim 24, wherein
the illumination optical system has a plurality of optical elements, and
out of the plurality of optical elements, at least one optical element positioned on the mask side from an intermediate light condensing point of the illumination light in an optical path of the illumination light is suspendingly supported.

28. A supporting method according to claim 27, wherein
the illumination optical system has at least one first optical element positioned to a light source side from the intermediate light condensing point in the optical path, and at least one second optical element positioned to the mask side from the intermediate light condensing point in the optical path,
and at least one the second optical element is suspendingly supported.

29. A supporting method according to claim 24, wherein the illumination optical system includes a plurality of reflecting surfaces, and of the reflecting surfaces, a shape of a reflecting surface closest to the mask along an optical path of the illumination light has curvature.

30. A supporting method according to claim 24, wherein on at least a part of the illumination optical system is installed a processing device that is driven with respect to an optical path of the illumination light to perform predetermined processing with respect to the illumination light.

31. A supporting method according to claim 24, wherein to at least a part of the illumination optical system is connected a tubular body that supplies a temperature adjustment medium.

32. A manufacturing method of an exposure apparatus in which illumination light is irradiated onto a pattern formed on a mask, and the pattern is exposed on a substrate, wherein
as a method of supporting at least part of the illumination optical system and the projection optical system, a supporting method according to claim 24 is employed.
